(19) United States
(12) Patent Application Publication
(10) Pub. No.: US 2010/0123804 A1
(43) Pub. Date: May 20, 2010

(54) EMOTION-BASED IMAGE PROCESSING APPARATUS AND IMAGE PROCESSING METHOD

(75) Inventor: Chao-Tsung TSAI, Hsinchu County (TW)

Correspondence Address: RABIN & Berdo, PC, 1101 14TH STREET, NW, SUITE 500, WASHINGTON, DC, 20005, US

(73) Assignee: Altek Corporation, Hsinchu (TW)

(21) Appl. No.: 12/410,657

(22) Filed: Mar. 25, 2009

(30) Foreign Application Priority Data
Nov. 19, 2008 (TW) 097144661

(51) Int. Cl. H04N 5/262

(52) U.S. Cl. 348/239; 348/E05.051

(57) ABSTRACT

An emotion-based image processing apparatus includes a shutter button for producing a first and a second control signal respectively according to different pressed stages, an image capturing unit for sensing an image data and sending an expression analysis instruction when it receives the first control signal and capturing the image data when it receives the second control signal, an expression database for storing expression feature information and corresponding image processing procedures, an expression analysis unit for receiving an expression analysis instruction to recognize face features in the image data and determine the expression feature information corresponding to the face features, and an image processing unit for performing the image processing procedures according to the determined expression feature information to process the image data captured by the image capturing unit.

### CROSS-REFERENCE TO RELATED APPLICATIONS

This non-provisional application claims priority under 35 U.S.C. § 119(a) on Patent Application No(s). 097144661 filed in Taiwan, R.O.C. on Nov. 19, 2008 the entire contents of which are hereby incorporated by reference.

### BACKGROUND OF THE INVENTION

1. Field of Invention

The present invention relates to an image processing apparatus and method, and more particularly, to an image processing apparatus and method for processing an image specially.

2. Related Art

In the multimedia environment, images have become a fairly important tool for information expression; however, the processing of an image (especially in term of image capturing) has been too highly specialized to be used by the averages, since image capture equipment is fairly expensive and cannot be afforded by the publics. Until recent years, with the progress of electronic and optical technologies, digital image capture equipments (for example, image scanners, digital cameras, and so on) appear in personalized market of low price, and gradually attract the attention of both consumers and manufacturers.

Digital cameras are new products that combine optical, precision machinery, and electronic technologies, which convert the images captured by a camera lens to digital image signals via a charge coupled device (CCD), and store the digital image signals in a storage media, for example, a magnetic disk, an optical disk, or an IC memory card, through the processing of an electronic circuit. On the other hand, the images can be displayed immediately on various displays (for example, TVs or monitors) for performing various reusing functions of images such as editing and modifying, which is quite convenient, time-saving, and cheap.

Most digital cameras now available in the market are equipped with a liquid crystal display, and the liquid crystal display can display visual scenes to a photographer in advance before capturing images, for the photographer to select a visual scene region to be shot. Moreover, the liquid crystal display can display various shoot parameters, such as light sensitiveness, white balance, exposure compensation, flasher activation, and focusing state. After the photographer presses a shutter to shoot, the results being shot can be seen immediately on the liquid crystal display. For the photographer, the display of the digital camera provides a number of convenient functions, and enables the photographer to get best results when shooting a photograph.

However, with the advent of multimedias times, users tend to expect the digital cameras to provide more quite different special functions to bring users different surprises and feelings, and among those functions, image processing function of a digital camera is also a consideration when users purchase a product.

Therefore, how to provide an image processing apparatus and method has become a problem to be solved by researchers.

### SUMMARY OF THE INVENTION

Accordingly, the present invention is directed to an emotion-based image processing apparatus and an image processing method, which can perform special image processing on image data captured by a digital camera according to current emotional responses of a photographed person, thereby adding the functions of current image processing and thus enhancing competitiveness of the product.

Therefore, the present invention provides an emotion-based image processing apparatus, which includes a shutter button, an image capturing unit, an expression database, an expression analysis unit, and an image processing unit. The shutter button is used for producing a first and a second control signal respectively according to pressed states. The image capturing unit is used for sensing and capturing an image data, senses the image data and sends an expression analysis instruction when it receives the first control signal, and captures the image data when it receives the second control signal. The expression database is used for storing a plurality of expression feature information and a plurality of special effect image processing procedures corresponding to each of the expression feature information. The expression analysis unit is used for receiving an expression analysis instruction to recognize at least one face feature in the image data sensed by the image capturing unit, and looking up the database according to each of the face features to determine the expression feature information corresponding to each of the face features. The image processing unit is used for performing each of the special effect image processing procedures according to the expression feature information determined by the expression analysis unit, so as to process the image data captured by the image capturing unit.

In addition, the present invention provides an emotion-based image processing method, which includes the following steps. Firstly, an image processing apparatus is provided, which includes at least one shutter button and an image capturing unit. The shutter button is half-pressed to produce a first control signal, and an image data is sensed via the image capturing unit when the first control signal is produced. An expression analysis unit is provided in the image processing apparatus, which performs an expression analysis procedure on the image data sensed by the image capturing unit to capture at least one face feature. An expression database is provided to the expression analysis unit, so that the expression analysis unit can look up the expression database according to each of the face features and determine at least one expression feature information corresponding to each of the face features. At least one special effect image processing procedure is decided according to each of the expression feature information. An image processing unit is provided for performing each of the special effect image processing procedures, which processes the image data captured by the image capturing unit. And finally, the shutter button is further full-pressed to output the processed image data when the shutter button produces the second control signal.

According to the emotion-based image processing apparatus and image processing method, the current emotional responses of a photographed person can be distinguished by recognizing the shape of the eyes and mouth of the photographed person, since people's face expressions (especially eyes and mouth) may vary with emotional responses. Thus, a digital camera can be controlled to perform special image processing on the captured image data, thereby adding the functions of current image processing and thus enhancing competitiveness of the product.

### BRIEF DESCRIPTION OF THE DRAWINGS

The present invention will become more fully understood from the detailed description given herein below for illustration only, and thus are not limitative of the present invention, and wherein:

FIG. 1 is a system block diagram of an emotion-based image processing apparatus according to the present invention.

FIG. 2 is a schematic view of an index table according to the present invention.

FIG. 3 is a flow chart of an emotion-based image processing method according to the present invention.

### DETAILED DESCRIPTION OF THE INVENTION

The emotion-based image processing apparatus disclosed by the present invention can be, but not limited to, applied to image input equipments such as digital cameras and network cameras, and can be built in an electronic apparatus including a window interface, such as a notebook, a PDA, a digital photo frame, and a mobile phone, so as to provide functions related to user's operations. However, the accompanying drawings are provided only for reference and illustration, and not for limitation of the present invention.

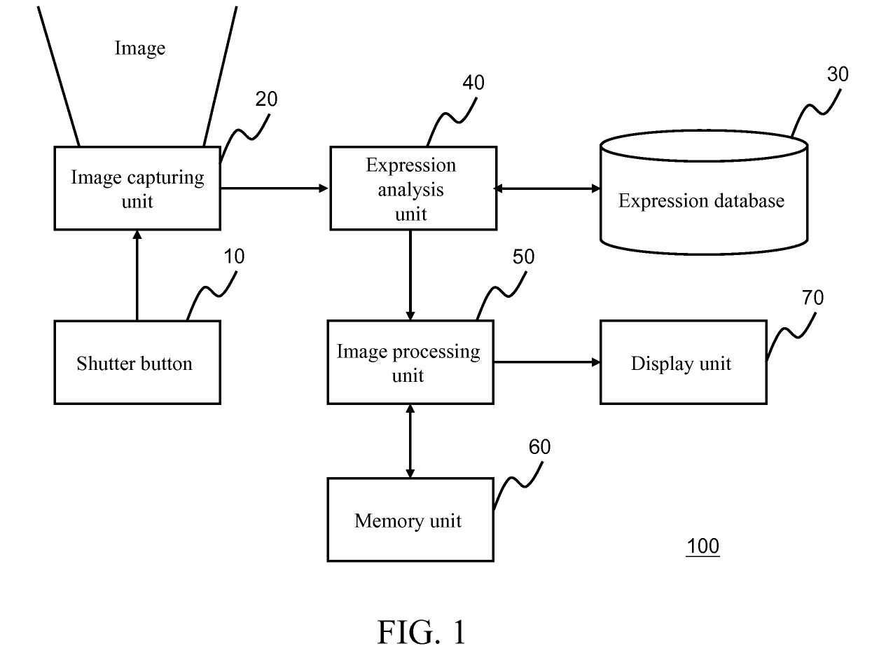

Referring to FIG. 1, a system block diagram of an emotion-based image processing apparatus according to the present invention is shown. As shown in FIG. 1, the emotion-based image processing apparatus 100 of the present invention includes a shutter button 10, an image capturing unit 20, an expression database 30, an expression analysis unit 40, an image processing unit 50, a memory unit 60, and a display unit 70.

The shutter button 10 can be constituted by switch devices (not shown) and a switch circuit. The shutter button 10 includes a half-pressed state and a full-pressed state according to different pressed stages by a user, and produces a first control signal and a second control signal respectively. The half-pressed state corresponds to the first control signal, and the full-pressed state corresponds to the second control signal. For example, during shooting, when a photographer presses the shutter button 10, the half-pressed state is performing an expression analysis procedure of the present invention and/or automatic focusing, while the full-pressed state is shooting.

The image capturing unit 20 is connected with the shutter button 10. The image capturing unit 20 is used for sensing an image and capturing an image data. The image capturing unit 20 senses the image data and sends an expression analysis instruction when it receives the first control signal. The image capturing unit 20 captures the image data and stores the image data on the memory unit 60 when it receives the second control signal. The image capturing unit 20 can be constituted by, for example, an optical lens module of a digital camera, a photoelectric sensing module such as a Charge-Coupled Device (CCD) or a Complementary Metal-Oxide Semiconductor (CMOS), and a digital imaging logical circuit module such as an Application Specific Integrated Circuit (ASIC).

The expression database 30 stores a plurality of expression feature information and a plurality of special effect image processing procedures corresponding to each of the expression feature information. The special effect image processing procedures may include regulating color tone, adding frame and/or collocating music. The correspondence of each of the expression feature information in the expression database 30 with the plurality of special effect image processing procedures can be realized as, for example, an index table.

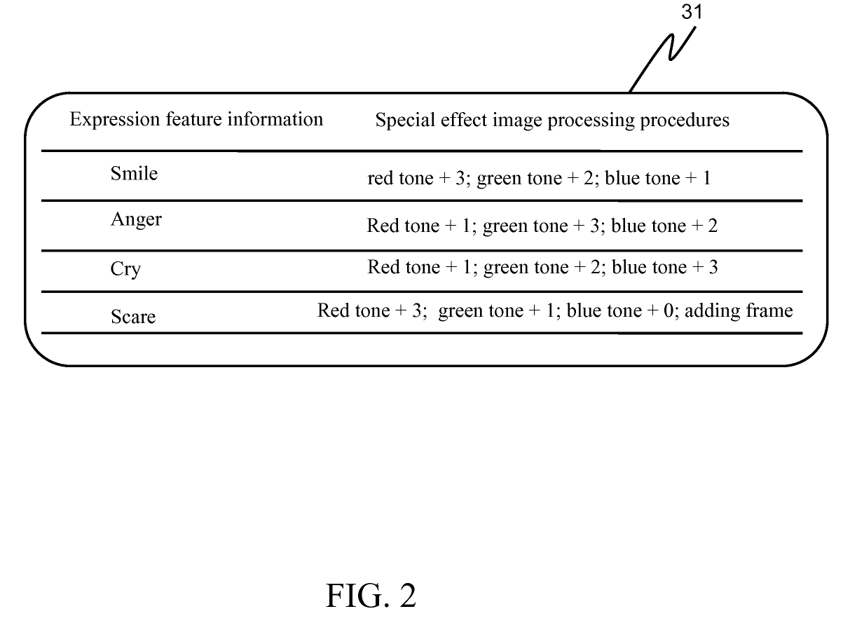

Referring to FIG. 2, a schematic view of an index table according to the present invention is shown. As shown in FIG. 2, the index table 31 records expressions such as smile, anger, cry, and scare, and the special effect image processing procedures corresponding to the expressions are set as follows: (1) red tone+3; green tone+2; blue tone+1; (2) red tone+1; green tone+3; blue tone+2; (3) red tone+1; green tone+2; blue tone+3; (4) red tone+3; green tone+1; blue tone+0; adding frame. In addition, users may also adjust the set parameters in the index table 31 by themselves.

The expression analysis unit 40 is connected with the image capturing unit 20 and the expression database 30 respectively. The expression analysis unit 40 is used for receiving the expression analysis instruction, so as to recognize at least one face feature (for example, eyes and/or mouth of one or more persons) in the image data sensed by the image capturing unit 20. If different persons have different emotional responses, it can be decided to perform which special effect image processing procedure according to most identical emotional responses, or according to few identical emotional responses.

Recognition of the face features can be realized via face detecting algorithms. The face detecting algorithms include image processing technologies and feature value capturing, wherein the image processing technologies include region division, blur, edge detection, and edge approximation. The targets of feature value capturing include feature values of eyes, the feature values of eyes take eye corners' coordinates as eyes' positions, and the positions of eyes in a face image are determined together with the above image processing technologies, and then feature vector values are calculated. The feature values of mouth take mouth corners' coordinates as mouth' position, the position of mouth in the face image is determined together with the above image processing technologies, and then feature vector values are calculated. Since people's face expressions (especially eyes and mouth) may vary with emotional responses, so the current emotional responses of a photographed person can be distinguished by recognizing the shape of the eyes and mouth of the photographed person. The expression analysis unit 40 looks up the expression database 30 according to each of the face features, so as to determine each of the expression feature information corresponding to each of the face features.

The image processing unit 50 is connected with the expression analysis unit 40. The image processing unit 50 performs each of the special effect image processing procedures according to each of the expression feature information determined by the expression analysis unit 40, for example, readjusts the tone scale of the image data according to the set parameters in the index table 31, or appends music files to the image data, so that when the processed image data is turned on, the appended music files are played simultaneously, so as to process the image data captured by the image capturing unit 20. The image processing unit 50 can be, for example, a central processor unit (CPU).

The memory unit 60 is connected with the image processing unit 50. The memory unit 60 is used for storing the image data captured by the image capturing unit 20. The memory unit 60 can be, for example, a memory or a hard disk.

The display unit 70 is connected with the image processing unit 50. The display unit 70 is used for displaying the image data processed by the image processing unit 50. The display unit 70 can be, for example, a liquid crystal display.

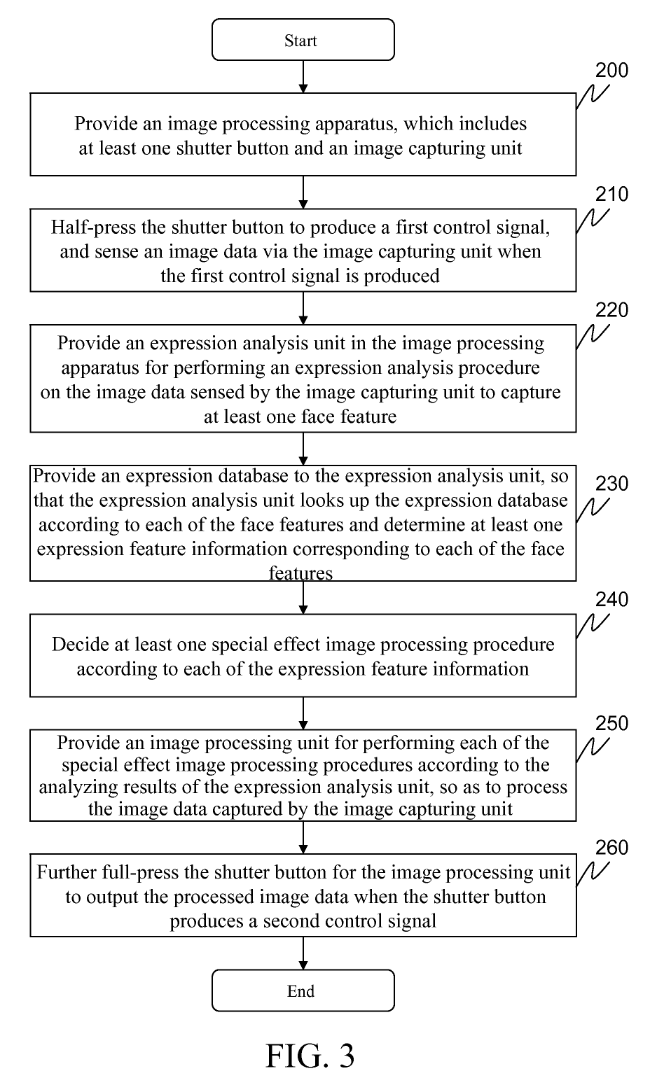

Referring to FIG. 3, a flow chart of an emotion-based image processing method according to the present invention is shown. As shown in FIG. 3, the emotion-based image processing method of the present invention includes the following steps.

Firstly, an image processing apparatus is provided, which includes at least one shutter button and an image capturing unit (step 200). The shutter button is half-pressed to produce a first control signal, and an image data is sensed via the image capturing unit when the first control signal is produced (step 210). The first control signal is produced when the shutter button is in a half-pressed state. The image capturing unit can be constituted by, for example, an optical lens module of a digital camera, a photoelectric sensing module (a CCD or a CMOS), and a digital imaging logical circuit module (ASIC).

Then, an expression analysis unit is provided in the image processing apparatus for performing an expression analysis procedure on the image data sensed by the image capturing unit to capture at least one face feature (step 220). The expression analysis procedure can be realized via face detecting algorithms. The face features include eyes and/or mouth of one or more persons.

An expression database is provided to the expression analysis unit, so that the expression analysis unit can look up the expression database according to each of the face features, and determine at least one expression feature information corresponding to each of the face features (step 230). The expression database stores a plurality of expression feature information and an index table of a plurality of special effect image processing procedures corresponding to each of the expression feature information.

At least one special effect image processing procedure is decided according to each of the expression feature information (step 240). The expression feature information includes expressions such as smile, anger, cry, and scare. The special effect image processing procedures include regulating color tone, adding frame, or collocating music, for example, readjusting the tone scale of the image data according to the set parameters in the index table, or appending music files to the image data, so that when the processed image data is turned on, the appended music files are played simultaneously.

An image processing unit is provided for performing each of the special effect image processing procedures according to the analysis results of the expression analysis unit, so as to process the image data captured by the image capturing unit (step 250). The image processing unit can be, for example, a CPU.

The shutter button is further full-pressed for the image processing unit to output the processed image data when the shutter button produces the second control signal (step 260). The second control signal is produced when the shutter button is in a full-pressed state. The image processing unit can output the processed image data to the memory unit for storage, and/or output the processed image data to the display unit for display.

To sum up, according to the emotion-based image processing apparatus and image processing method, the current emotional responses of a photographed person can be distinguished by recognizing the shape of the eyes and mouth of the photographed person, since people's face expressions (especially eyes and mouth) may vary with emotional responses. Thus, a digital camera can be controlled to perform special image processing on the captured image data, thereby adding the functions of current image processing and thus enhancing competitiveness of the product.

What is claimed is:

1. An emotion-based image processing apparatus, comprising:
a shutter button, for producing a first control signal and a second control signal respectively according to different pressed states;
an image capturing unit, for sensing and capturing an image data, wherein the image capturing unit senses the image data and sends an expression analysis instruction when it receives the first control signal, and captures the image data when it receives the second control signal;
an expression database, for storing a plurality of expression feature information and a plurality of special effect image processing procedures corresponding to the expression feature information;
an expression analysis unit, for receiving the expression analysis instruction to recognize at least one face feature in the image data sensed by the image capturing unit, and looking up the expression database according to the face features to determine the expression feature information corresponding to the face features; and
an image processing unit, for performing the special effect image processing procedures according to the expression feature information determined by the expression analysis unit, so as to process the image data captured by the image capturing unit.

2. The emotion-based image processing apparatus according to claim 1, wherein the pressed states comprise a shutter button half-pressed state corresponding to the first control signal and a shutter button full-pressed state corresponding to the second control signal.

3. The emotion-based image processing apparatus according to claim 1, wherein the special effect image processing procedures comprise adjusting color tone, adding frame, or collocating music.

4. The emotion-based image processing apparatus according to claim 1, comprising:
a memory unit, for storing the image data captured by the image capturing unit; and
a display unit, for displaying the image data processed by the image processing unit.

5. An emotion-based image processing method, comprising:
providing an image processing apparatus, which comprises at least one shutter button and an image capturing unit;
half-pressing the shutter button to produce a first control signal, and sensing an image data via the image capturing unit when the first control signal is produced;
providing an expression analysis unit in the image processing apparatus for performing an expression analysis procedure on the image data sensed by the image capturing unit to capture at least one face feature;
providing an expression database to the expression analysis unit, so that the expression analysis unit looks up the expression database according to the face features and determine at least one expression feature information corresponding to the face features;
deciding at least one special effect image processing procedure according to the expression feature information;
providing an image processing unit for performing the special effect image processing procedures, so as to process the image data captured by the image capturing unit; and
further full-pressing the shutter button to output the processed image data when the shutter button produces a second control signal.

6. The emotion-based image processing method according to claim 5, wherein the expression feature information comprise smile, anger, cry, and scare.

7. The emotion-based image processing method according to claim 5, wherein the special effect image processing procedures comprise adjusting color tone, adding frame, or collocating music.
